(19) United States
(12) Patent Application Publication
(10) Pub. No.: US 2013/0044025 A1
(43) Pub. Date: Feb. 21, 2013

(54) SATELLITE-BASED POSITIONING METHOD

(71) Applicant: Shang-Ming Chiu, Taipei (TW)

(72) Inventor: Shang-Ming Chiu, Taipei (TW)

(73) Assignee: GETAC TECHNOLOGY CORPORATION, Hsinchu (TW)

(21) Appl. No.: 13/244,564

(22) Filed: Sep. 25, 2011

(30) Foreign Application Priority Data
Aug. 16, 2011 (CN) CN201110245162.8

(51) Int. Cl. G01S 19/42

(52) U.S. Cl. 342/357.25

(57) ABSTRACT

A satellite-based positioning method is applicable in a Global Positioning System (GPS) receiver. The satellite-based positioning method includes the steps of obtaining multiple satellites in use by searching; calculating every satellite vector between each of the satellites in use and the GPS receiver; selecting three of the satellites in use in sequence as a satellite candidate set, searching for one of the satellite candidate set forming a geometric error relation according to the multiple satellite vectors, and using at least one of the satellites in use in the satellite candidate set forming the geometric error relation as a first satellite; searching for at least one second satellite in the satellites in use, wherein a signal strength varied rate of the second satellite is greater than a varied rate threshold; and using the satellites in use having the first satellite or the second satellite removed to perform positioning.

### BACKGROUND

1. Field

The disclosure relates to a satellite-based positioning method, and more particularly to a satellite-based positioning method for improving the positioning accuracy.

2. Related Art

The Global Positioning System (GPS) is a global spaced-based positioning system developed by the United States Department of Defense, which is initially used in military applications, for example, military aircraft navigation and missile remote control. However, the current application of the GPS has gradually entered the daily life of each person. For example, vehicle navigation with an electronic map enables a driver to reach a destination easily. Or, in leisure activities, a hiker or mountain-climber can find the destination and the way home by using the GPS function.

The GPS continuously sends satellite signals containing satellite location information through twenty four artificial satellites distributed in the six orbital planes around the Earth.

Moreover, ground control stations are disposed in various places globally to manage operation and correction of the satellite system. A user uses a GPS receiver to receive the satellite signals and obtain information of the user's position. After the GPS receiver receives the satellite signals, computation is performed by a microprocessor system. The Orientation coordinate of the user are calculated through delays of signals transmitted by different satellites by using the triangulation. The strength of the received signals directly affects the positioning accuracy.

The Wide Area Augmentation System (WAAS) or the Assisted Global Positioning System (AGPS) have been developed to improve the positioning accuracy by correcting satellite ephemeris or almanac data. However, areas covered by a WAAS service are limited, so it is difficult to obtain a true corrected position. Once an AGPS service is away from service stations, the correction capability of the AGPS service is degraded. Otherwise, if a shelter exists in the environment, the correction provided by the WAAS and the AGPS both deteriorate.

### SUMMARY

According to an embodiment, a satellite-based positioning method comprises: obtaining multiple satellites in use by searching; calculating every satellite vector between each of the satellites in use and a GPS receiver; searching for three of the satellites in use forming a geometric error relation according to the satellite vectors, and taking at least one of the three satellites in use forming the geometric error relation as a first satellite; searching for at least one second satellite in the satellites in use, where a signal strength varied rate of the second satellite is greater than a varied rate threshold; and using the satellites in use other than the first satellite and the second satellite removed to perform positioning.

According to another embodiment, a satellite-based positioning method comprises: obtaining multiple satellites in use by searching; calculating a satellite vector between each of the satellites in use and a GPS receiver; searching for three of the satellites in use forming a geometric error relation according to the satellite vectors, and using at least one of the three satellites in use forming the geometric error relation as a first satellite; searching for at least one second satellite in the satellites in use, where a signal strength varied rate of the second satellite is greater than a varied rate threshold; calculating a deviation of current positioning; and when the deviation of current positioning is greater than a deviation threshold, using the satellites in use other than the first satellite or the second satellite removed to perform positioning.

### BRIEF DESCRIPTION OF THE DRAWINGS

The disclosure will become more fully understood from the detailed description given herein below for illustration only, and thus are not limitative of the disclosure, and wherein:

FIG. 1 is a flow chart of a satellite-based positioning method according to an embodiment;

FIG. 2 is a flow chart of Step S100 according to an embodiment;

FIG. 3 is a schematic view of satellites in use and satellites in-view according to an embodiment;

FIG. 4 is a schematic view of a geometric error relation according to an embodiment;

FIG. 5 is a flow chart of Step S500 according to an embodiment;

FIG. 6 is a flow chart of Step S500 according to an embodiment;

FIG. 7 is a flow chart of a satellite-based positioning method according to an embodiment;

FIG. 8 is a schematic view of the signal strength and a deviation according to an embodiment;

FIG. 9 is a schematic view of the signal strength and a deviation according to an embodiment;

FIG. 10 is a schematic view of a signal strength varied rate, an elevation angle, and a deviation according to an embodiment;

FIG. 11 is a schematic view of a fixed strength mask value and a deviation according to an embodiment;

FIG. 12 is a schematic view of an adjusted strength mask value and a deviation according to an embodiment; and

FIG. 13 is a schematic comparison view of deviations according to an embodiment.

### DETAILED DESCRIPTION

The detailed features and advantages of the disclosure are described below in great detail through the following embodiments, the content of the detailed description is sufficient for persons skilled in the art to understand the technical content of the disclosure and to implement the disclosure there accordingly. Based upon the content of the specification, the claims, and the drawings, persons skilled in the art can easily understand the relevant objectives and advantages of the disclosure.

The disclosure relates to a satellite-based positioning method, which is applicable in a GPS receiver and can provide high-accuracy satellite-based positioning services. The GPS receiver may be configured in mobile electronic devices, such as mobile phones, personal digital assistants (PDA), or notebook computers, and may also be configured in vehicles such as automobiles to provide satellite-based positioning services.

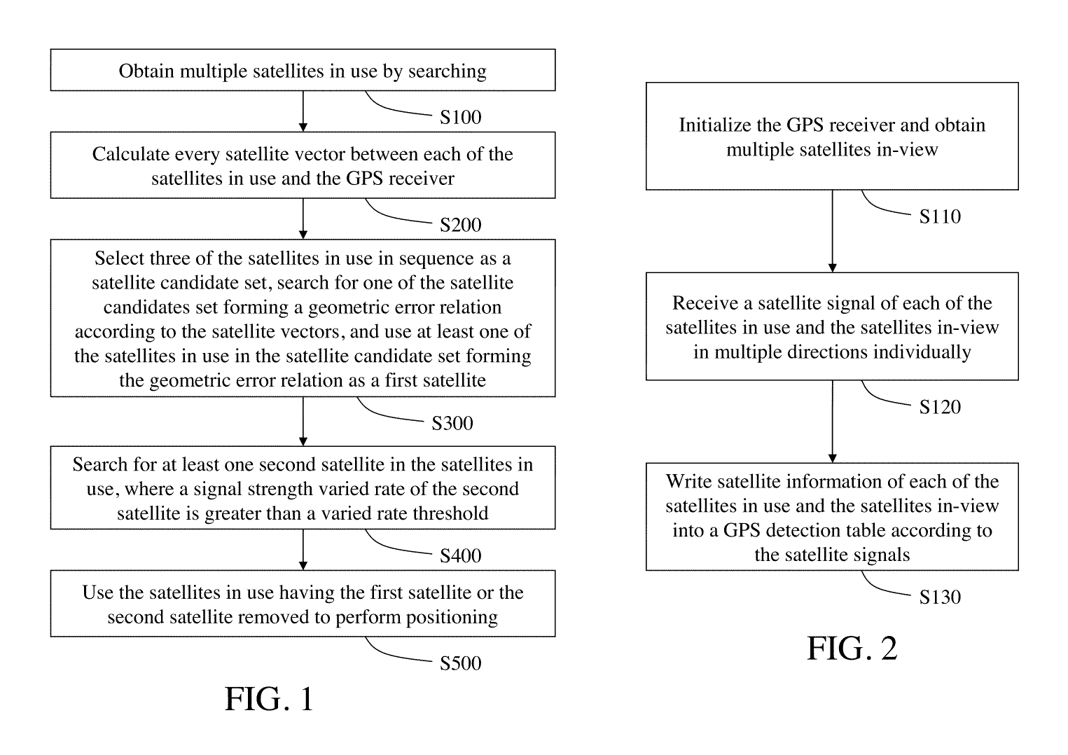

FIG. 1 is a flow chart of a satellite-based positioning method according to an embodiment. As shown in FIG. 1, in order to obtain satellites capable of being used to perform accurate positioning, multiple satellites in use are obtained initially by searching (Step S100). Except the purpose of searching for the satellites in use, Step S100 may comprise the steps as shown in FIG. 2 used for finding out an environment where the GPS receiver is located and a possible effect on positioning.

FIG. 2 is a flow chart of Step S100 according to an embodiment. A GPS receiver may first be initialized, and obtain multiple satellites in-view according to a built-in satellite ephemeris or a built-in satellite almanac data received from a nearby mobile phone base station (Step S110). The satellites in-view comprise all of the satellites in use. The GPS receiver may receive a satellite signal of each of the satellites in use and the satellites in-view in multiple directions individually (Step S120).

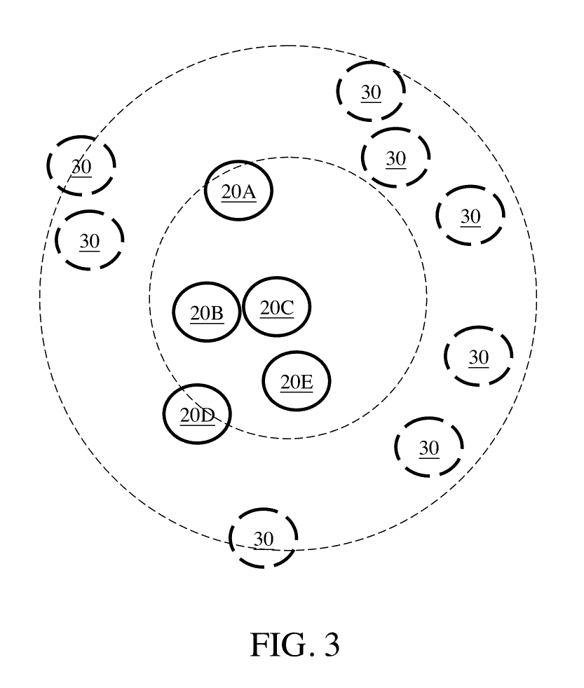

FIG. 3 is a schematic view of satellites in use and satellites in-view according to an embodiment of the disclosure.

In the embodiment as shown in FIG. 3, according to the satellite-based positioning method, the satellites in-view 30 and the satellites in use 20A to 20E (which are collectively referred to as satellites in use 20 hereinafter) are obtained. According to the satellite-based positioning method, all GPS artificial satellites with satellite signals capable of being received by the GPS receiver may first be chosen as satellites in-view 30, and then some of the satellites in-view 30 having better reception intensity are chosen as satellites 20 in use. In some embodiments, the satellites in-view 30 may all be set as the satellites in use 20. Alternatively, in some embodiments, a part of the satellites in-view 30 are not chosen as the satellites in use 20, and such satellites in-view 30 not chosen are also referred to as tracking satellites used as spares.

A calculation for finding the position may be regarded as solving a ternary linear equation having three variables (X, Y, Z), so at least three satellite signals are required to be used as known data. In other words, according to the satellite-based positioning method, only three satellites need to be found and used as the satellites in use 20, and, then, the longitude and latitude coordinates of the location can be calculated. When four satellites in use 20 are used, a time error that occurs when the satellite signals are received can be eliminated. Normally, the GPS receiver keeps receiving signals from four satellites in use 20 at anytime. Furthermore, in Step S100, the GPS receiver may perform preliminary satellite-based positioning, and obtains a preliminary position. The preliminary position refers to the location of the GPS receiver obtained through preliminarily calculation before the GPS receiver performs subsequent Step S200 to Step S500.

According to the satellite ephemeris data, which is also referred to as almanac data, and the received satellite signals, the GPS receiver can obtain satellite information of each of the satellites. According to the received satellite signals, the satellite information of each of the satellites in use 20 and the satellites in-view 30 is written into a GPS detection table, for performing the positioning in the following. Each piece of satellite information may comprise a signal strength value, a satellite altitude value, an azimuth angle, and an elevation angle of the satellite in use 20 or the satellite in-view 30. The carrier-to-noise ratio (CNR) of the satellite signal may be used as the signal strength value.

In addition, in order to obtain an accurate location as soon as possible, initial positioning information may be obtained according to a vector relation to a satellite-based augmentation system (SBAS) mask value. Besides, after the GPS receiver is restarted, the initial positioning information may be directly obtained by the SBAS.

After the satellite information possibly needed is obtained in Step S100, according to the satellite-based positioning method, a satellite vector between each of the satellites in use 20 and the GPS receiver is calculated (Step S200). Specifically, several three-dimensional (3D) vectors, with the GPS receiver as a starting point and each of the satellites in use 20 as an ending point, may be calculated and used as the satellite vectors.

According to the above-mentioned satellite vectors and satellite information, in the satellite-based positioning method, at least one of the satellites that may decrease the positioning accuracy is found to be excluded in Step S300 and Step S400 as follows.

Three of the satellites in use 20 are selected in sequence as a satellite candidate set, one of the satellite candidate sets forming a geometric error relation is searched for according to the satellite vectors, and at least one of the satellites in use 20 in the satellite candidate set forming the geometric error relation is defined as a first satellite (Step S300).

The locations of the three satellites in use 20 are calculated by solving the ternary linear equation having the three variables (X, Y, Z) and a triangle is formed by the three locations of the three satellites in use 20. The obtaining the location by solving the ternary linear equation is geometrically similar to obtaining the coordinate of the center of gravity of the triangle. Therefore, the optimal situation is that the three satellites in use 20 used for the solution geometrically form a regular triangle Therefore, in this way, even if the content of any one of the satellite signals is inaccurate, the influence on calculated solutions is slighter, and a calculation error (that is, a geometric error) is not likely to be caused.

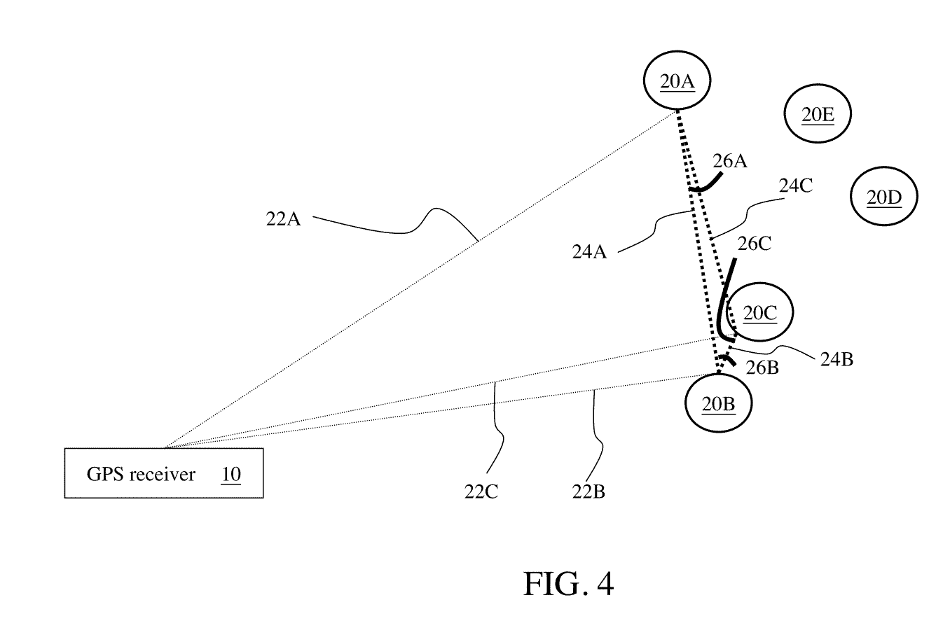

FIG. 4 is a schematic view of a geometric error relation according to an embodiment. However, in the embodiment in FIG. 4, the satellites in use 20A, 20B, and 20C form a triangle with a sharp angle.

In terms of obtaining the coordinate of the center of gravity of the sharp triangle, an error is likely to occur on an axis connecting the satellite in use 20A to a midpoint of the satellites in use 20B and 20C. Therefore, when the three satellites in use 20A, 20B, and 20C are used to calculate the position, a geometric error is likely to occur, and the three satellites in use 20A, 20B, and 20C form a geometric error relation.

In an embodiment, in order to determine whether any three of the satellites in use 20 forms the geometric error relation, three of the satellites in use 20 may be selected in sequence as a satellite candidate set first. For example, in the embodiment in FIG. 4, the satellites in use 20A, 20B, and 20C are selected as a satellite candidate set first, and then the satellites in use 20A, 20B, and 20D or the satellites in use 20A, 20B, and 20E are selected as a satellite candidate set.

Taking the satellite candidate set of the satellites in use 20A, 20B, and 20C as an example, subtraction is performed on any two of satellite vectors 22A, 22B, and 22C to obtain three vectors 24A, 24B, and 24C between the satellites (which are collectively referred to as vectors 24 between satellites hereinafter). According to the vectors 24 between the satellites, three angles between the satellites 26A, 26B, and 26C (which are collectively referred to as angles between satellites 26 hereinafter) can be obtained by using the formula

$$cos θ = \frac{{V}_{1} \cdot {V}_{2}}{‖ \sqrt{{V}_{1}} ‖ ‖ \sqrt{{V}_{2}} ‖} .$$

In Step S300, all triangles formed by the satellites in use 20 can be found, each of the angles between the satellites 26 is calculated one after another, and it is determined whether any one of the angles between the satellites 26 is smaller than a threshold angle by searching and checking.

When an angle between the satellites (for example the angle between the satellites angle 26A) is smaller than the threshold angle, the satellite candidate set having the angle smaller than the threshold angle is considered as the three satellites in use 20 forming the geometric error relation, and at least one of the three satellites in use 20A, 20B, and 20C forming the geometric error relation is classified as the first satellite. For example, a satellite in use 20 with the weakest signal strength or the smallest elevation angle in the satellite candidate set may be classified as the first satellite. For example, in Step S300, the satellite in use 20B may be set as the first satellite.

In another embodiment, after three of the satellites in use 20 are selected in sequence as the satellite candidate set, an azimuth angle θi between each of satellites in use i in the satellite candidate set and the GPS receiver 10 is calculated one by one according to the satellite vectors. When an azimuth angle θj of any one of other obtained satellites in use j of the satellite candidate set is smaller than (θi+π/2) or greater than or equal to (θi−π/2), the satellite candidate set having the satellite in use j with the azimuth angle θj smaller than (θi+π/2) or greater than or equal to (θi−π/2) is used as the satellite candidate set forming the geometric error relation, and the satellite in use j having the azimuth angle θj smaller than (θi+π/2) or greater than or equal to (θi−π/2) is classified as the first satellite.

According to the satellite-based positioning method, at least one second satellite among the satellites in use is searched for. A signal strength varied rate of the second satellite is greater than a varied rate threshold (Step S400). The signal strength varied rate may be 0.2 decibel/second (dB/sec), but is not limited to the above-mentioned rate. Normally, when a shelter exists in the environment around the GPS receiver 10, the signal strength varied rate is likely to be increased. A large signal strength varied rate is likely to cause errors in signal interpretation, and, thereby, resulting in inaccurate positioning, so the satellite in use 20 with the large signal strength varied rate is practically not suitable for positioning. In other words, the satellites in use 20 having the problem of sheltering can be found in Step S400.

The signal reception model, a correction orientation, and a correction signal strength of the GPS receiver 10 in Step S100 may be used in Step S300 and Step S400. For example, when an antenna of the GPS receiver 10 is directed to the south, the satellite signal received from any other satellites is attenuated by at least 10 dB. Before the signal strength varied rate is calculated, the signal strength of each of the satellite signals received when the antenna is directed to the correction orientation is added with the correction signal strength. Thus, the situation that poor signal reception resulted from the GPS receiver 10 or the environment is incorrectly ascribed to the current satellites in use 20 and the suitable satellite in use 20 is incorrectly considered as the first satellite or the second satellite can be avoided.

Furthermore, in some embodiments, the execution order of Step S300 and the Step S5400 may be changed, and, in some embodiments, only one of the first satellite and the second satellite is found.

After the first satellite or the second satellite not suitable for positioning is found and the satellite information of the first satellite and the second satellite is recorded in Step S300 and Step S400, the satellites in use 20 having the first satellite or the second satellite removed are used to perform positioning (Step S500). It is assumed that in the embodiments in FIG. 3 and FIG. 4, the satellite in use 20B is determined as the first satellite and the satellite in use 20D is determined as the second satellite. According to the satellite-based positioning method, only the satellites in use 20A, 20C, and 20E are used for positioning in Step S500.

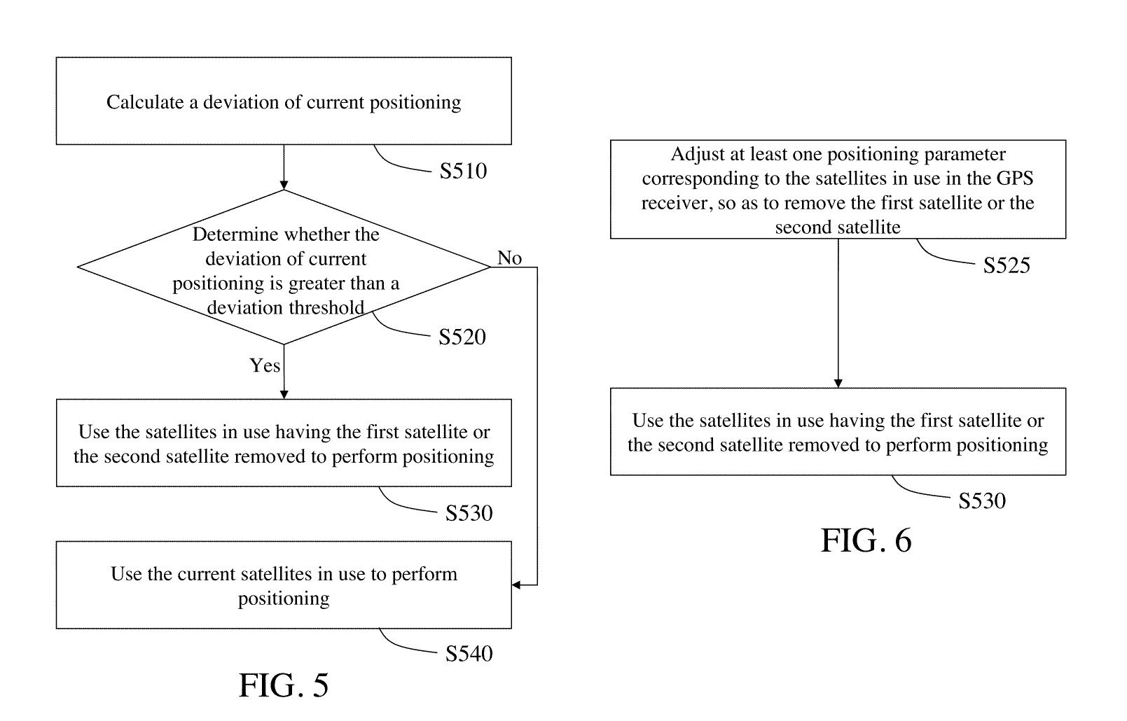

Step S500 may comprise steps as shown in FIG. 5 or FIG. 6.

In order to determine the positioning accuracy, a deviation of current positioning is calculated first (Step S510), and whether the deviation of current positioning is greater than a deviation threshold is determined (Step S520). After Step S100 where the preliminary position is obtained, according to the satellite-based positioning method, the same satellites in use 20 can be continuously used to perform positioning, and a difference between each positioning result and the actual location is recorded as a deviation variable. In Step S510, according to the satellite-based positioning method, a variation coefficient (CV) or a two-dimensional root-mean-square (2DRMS) deviation of the deviation variable to the current moment can be calculated as the deviation of current positioning. When the deviation of current positioning is greater than the deviation threshold, it indicates that the original positioning method cannot meet the desired accuracy requirements, so the satellites in use 20 having the first satellite or the second satellite removed are used to perform positioning (Step S530). On the contrary, if the deviation of current positioning is smaller than the deviation threshold, the current satellites in use 20 can be continuously used for performing positioning (Step S540).

The deviation threshold may be a default value or a value set by a user. For example, the user may set the desired accuracy to be two meters or one meter. If the positioning by the current satellites in use 20 cannot meet the requirement, Step S530 needs to be performed to obtain a more accurate positioning result. In other words, various convergence conditions in the satellite-based positioning method may be built or defined by the user so as to make the satellite-based positioning method meet demands of the user in different signal reception models.

Before Step S530, according to the satellite-based positioning method, at least one positioning parameter corresponding to the satellites in use 20 in the GPS receiver may be adjusted, so as to remove the first satellite or the second satellite (Step S525).

According to an embodiment, the positioning parameter may comprise a strength mask value, and it is defined that only the signal strength of the satellite greater than the strength mask value can be used as the satellite in use 20. In Step S525, when the first satellite or the second satellite is the satellite in use 20 having the lowest signal strength value, the strength mask value may be increased to remove the satellite in use 20 having the lowest signal strength value. For example, among all of the satellites in use 20, the current signal strength value of the satellite in use 20D set as the second satellite is the lowest and is 25 dB. According to the satellite-based positioning method, the strength mask value may be slightly increased to 30 dB to remove the satellite in use 20D and make the satellite in use 20D become a tracking satellite.

According to another embodiment, the positioning parameter may comprise an elevation angle mask value, and it is defined that only the satellite with the elevation angle greater than the elevation angle mask value can be classified as the satellite in use 20. In Step S525, when the first satellite or the second satellite is the satellite in use 20 having the lowest signal strength, the elevation angle mask value may be increased gradually at an elevation angle spacing, until the satellite in use 20 having the smallest elevation angle is removed. For example, among all of the satellites in use 20, the current elevation angle of the satellite in use 20B set as the second satellite is the smallest and is 10 degree. According to the satellite-based positioning method, the elevation angle mask value exerts greater influence, so the elevation angle mask value is gradually increased by 0.5 degree of the elevation angle spacing until the satellite in use 20B is removed.

In addition to the above-mentioned strength mask value and the elevation angle mask value, the positioning parameters in the satellite-based positioning method, such as GPS firmware parameters, an including power value, and the SBAS mask value may be further adjusted, so as to obtain a more accurate positioning result.

In addition, in Step S520, besides determining whether the deviation of current positioning is greater than the deviation threshold, other conditions may also be considered and determined.

According to an embodiment, only when the deviation of current positioning is greater than the deviation of previous positioning and the deviation of current positioning is greater than the deviation threshold, Step S525 and Step S530 are performed. The deviation of previous positioning may also be obtained by calculating the CV or the 2DRMS deviation. When the deviation of current positioning is greater than the deviation of previous positioning and the deviation threshold, it indicates that the current satellite-based positioning ability deteriorates. Therefore, according to the satellite-based positioning method, the satellites in use 20 having the first satellite or the second satellite removed are used to perform positioning, so as to improve the positioning accuracy.

According to another embodiment, in the satellite-based positioning method, the Taylor expansion may be applied to obtain a changing trend of the positioning accuracy and calculate a pre-estimated deviation of positioning. Only when the deviation of current positioning is greater than both the pre-estimated deviation of positioning obtained by previous estimation and the deviation threshold, the satellites in use 20 having the first satellite or the second satellite removed are used for positioning.

Besides being applied to calculate the pre-estimated deviation of positioning, the Taylor expansion may also be applied to calculate a pre-estimated position according to the preliminary position obtained by the previous positioning. Furthermore, if it is found that the position obtained by the positioning or the deviation variable are far different from the pre-estimated results, it indicates that the satellite signals received at this time may not be suitable for use and need to be abandoned. The GPS satellite normally sends a satellite signal every 1/20 second, but the GPS receiver may provide the position to a device equipped with the GPS receiver every several seconds (for example 5 seconds) due to limitations of a receiving chip of the GPS receiver. Therefore, even when some satellite signals are too poor to be retained, the subsequent satellite signals of the satellite-based positioning method can be continuously received, and the location is provided within a time period for updating.

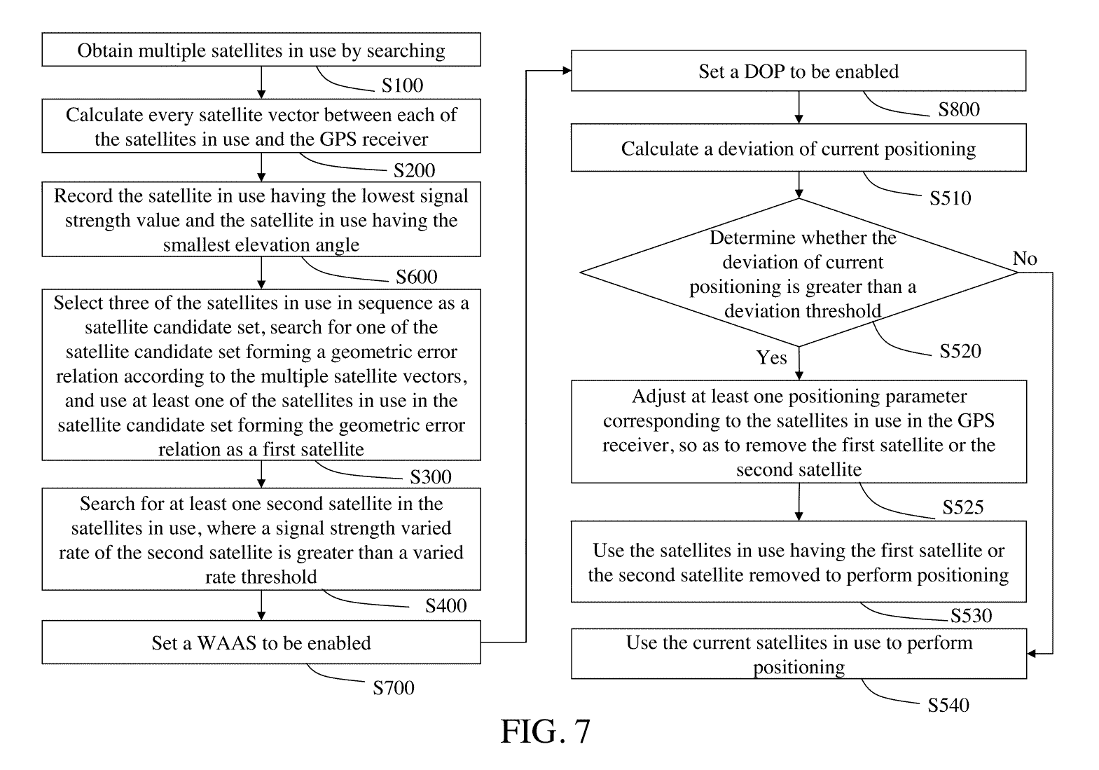

FIG. 7 is a flow chart of a satellite-based positioning method according to an embodiment.

As shown in FIG. 7, before the positioning parameter is adjusted, according to the satellite-based positioning method, the satellite in use 20 having the lowest signal strength value and the satellite in use 20 having the smallest elevation angle are further recorded (Step S600). In fact, Step S600 may be performed between Step S100 and Step S525. When Step S525 is performed, it may be determined whether the first satellite or the second satellite and the satellites in use 20 recorded in Step S600 are the same satellite, and then, the strength mask value or the elevation angle mask value is adjusted to exclude the first satellite and the second satellite in the satellites in use 20.

For example, in Step S600, when the satellite in use 20D is first recorded that the satellite in use 20D has the lowest signal strength value, and then in Step S400, the satellite in use 20D is classified as the second satellite. In Step S525, only the strength mask value needs to be adjusted to be slightly greater than the signal strength value of the satellite in use 20D, so as to remove the satellite in use 20D from all of the satellites in use 20. Thus, parameter needs to be adjusted can be properly judged, and the satellites in use 20 other than the first satellite and the second satellite are prevented from being removed.

In order to improve the positioning accuracy, if the GPS receiver is in a country that a WAAS signal can be received, a WAAS parameter is set to be enabled (Step S700). The satellite-based positioning system may also set a Dilution of Precision (DOP) to be enabled (Step S800). Similarly, the satellite-based positioning method may also enable other functions capable of assisting positioning, such as geometric dilution of precision (GDOP). The step of enabling the WAAS or DGOP and the step of adjusting the positioning parameters may be performed simultaneously.

According to an embodiment, the satellite-based positioning method includes calculating the satellite vector between each of the satellites in-view 30 and the GPS receiver, and searching for the first satellite or the second satellite in the tracking satellites. After the first satellite or the second satellite is removed, it may happen that the number of the remaining satellites in use 20 is less than three. In this case, at least one tracking satellite having better signal strength or a larger elevation angle is searched in all of the tracking satellites, and at least one positioning parameter is adjusted to add the at least one better tracking satellite to the satellite in use 20. In Step S530, the satellites in use 20 having the first satellite or the second satellite removed and the tracking satellite newly added can be used to perform positioning.

However, before the addition of the tracking satellite, it may first be determined whether the newly added tracking satellite satisfies the requirements of being the first satellite or the second satellite. If the tracking satellite is added, but becomes the first satellite or the second satellite, the tracking satellite is not suitable for being added to the satellites in use 20. In Step S300 and Step S400, according to the satellite-based positioning method, all the satellites in-view 30 may also be searched for the first satellite or the second satellite directly, so as to determine whether there is a satellite not suitable for positioning in the satellites in use 20 or the tacking satellites.

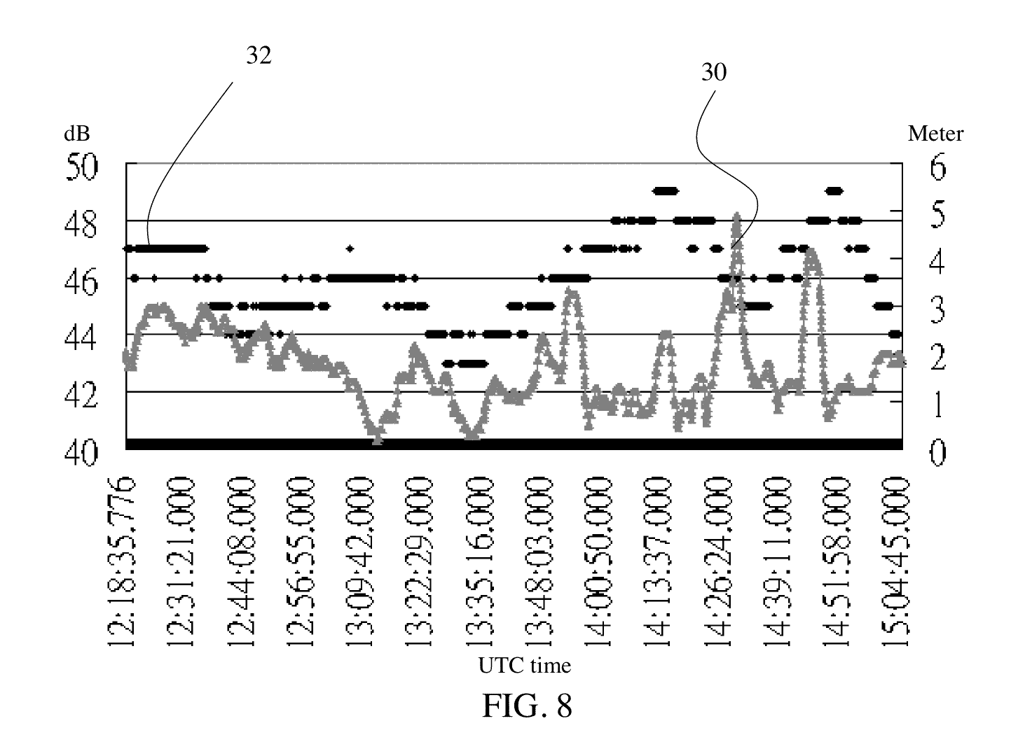

In the following, referring to FIG. 8 to FIG. 13, data examples of the satellite-based positioning method are shown below.

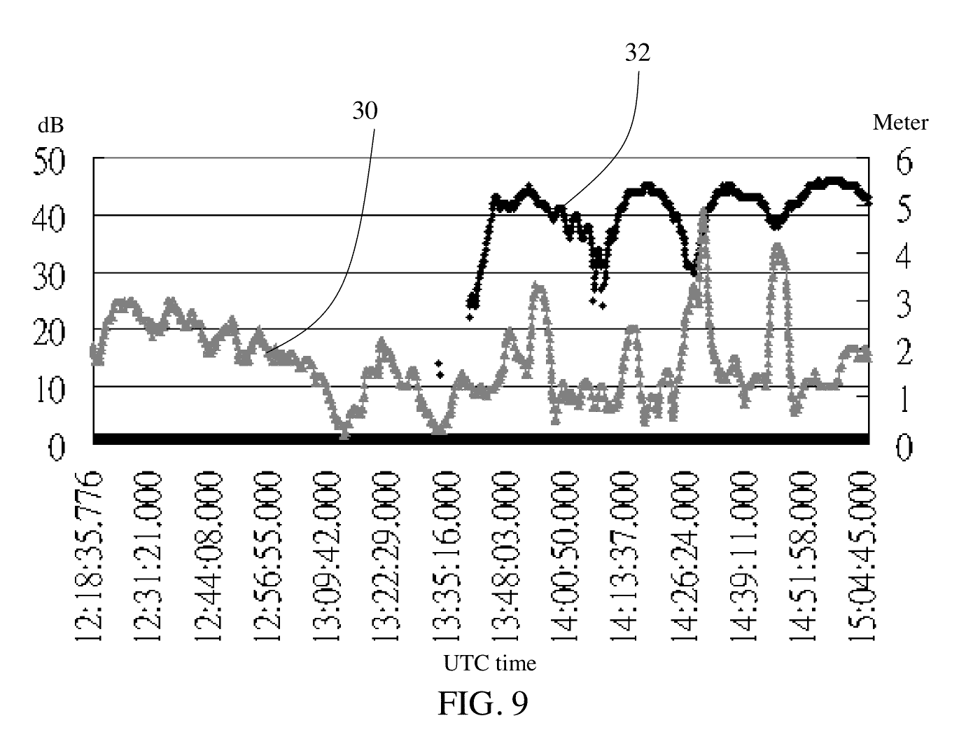

FIG. 8 is a schematic view of the signal strength and a deviation according to an embodiment. FIG. 9 is a schematic view of the signal strength and a deviation according to an embodiment. In FIG. 8 and FIG. 9, the unit of the left side of the vertical axis is decibel (dB), and the unit of the right side of the vertical axis is meter. FIG. 8 and FIG. 9 respectively illustrate a signal strength curve 32 of satellite signals received from different satellites in use 20 and an incurred deviation curve 31. The deviation curve 31 corresponds to the right side of the vertical axis and the signal strength curve 32 corresponds to the left side of the vertical axis. It can be seen from FIG. 8 that, approximately at Coordinated Universal Time (UTC) time 14:29:17, the deviation of positioning is obviously influenced due to the decreasing of the signal strength. Similarly, in FIG. 9, approximately at UTC time 14:06:07 and 14:53:55, the deviation is increased dramatically due to the decreasing of the signal strength.

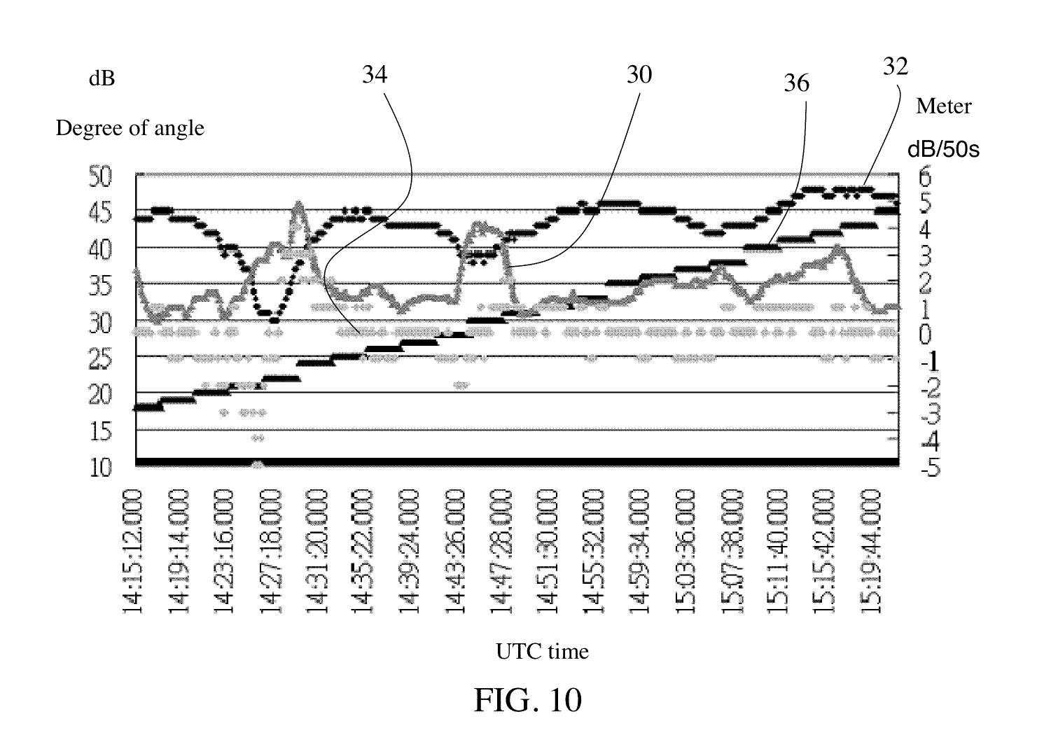

FIG. 10 is a schematic view of a signal strength varied rate, an elevation angle, and a deviation according to an embodiment. FIG. 10 illustrates a signal strength curve 32, a signal strength varied rate curve 34, an elevation angle curve 36 of a satellite in use, and an incurred deviation curve 31. The deviation curve 31 corresponds to the right side of the vertical axis and the unit is meter. The signal strength curve 32 corresponds to the left side of the vertical axis and the unit is dB. The signal strength varied rate curve 34 corresponds to the right side of the vertical axis and the unit is the signal strength varied rate per fifty seconds (dB/50s). The elevation angle curve 36 corresponds to the right side of the vertical axis and the unit is angle in degree. It can be seen that when the elevation angle is smaller and the signal strength varied rate fluctuates dramatically, a larger deviation is incurred.

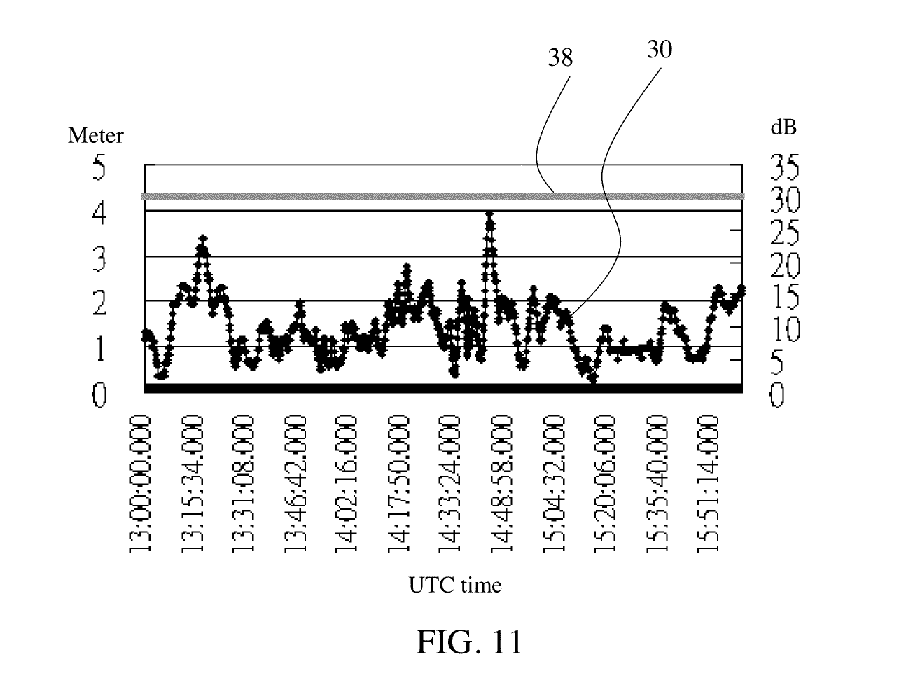

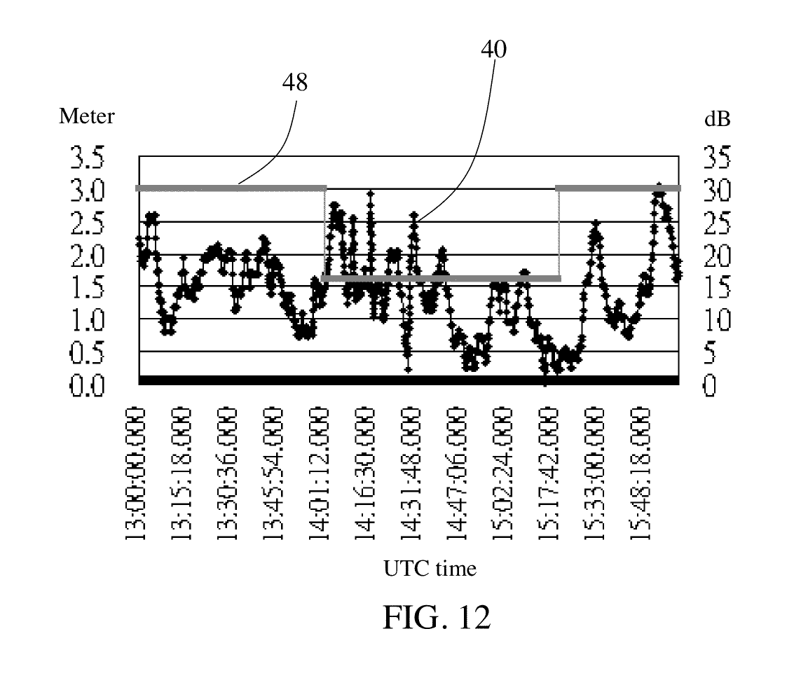

FIG. 11 is a schematic view of a fixed strength mask value and a deviation according to an embodiment. FIG. 12 is a schematic view of an adjusted strength mask value and a deviation according to an embodiment. In FIG. 11 and FIG. 12, the unit of the left side of the vertical axis is meter, and the unit of the right side of the vertical axis is decibel (dB). FIG. 11 and FIG. 12 individually illustrate a fixed strength mask value curve 38 and an adjusted strength mask value curve 48. In FIG. 11, the strength mask value is 30 dB and fixed, and the elevation angle mask value is 7.5 degree. In FIG. 12, the strength mask value is adjusted according to Step S400 to Step S500, and the elevation angle mask value is also 7.5 degree. It can be seen that the deviations in FIG. 11 can be up to 4 meters at most, and the average of the deviations is about 2 meters. However, the deviations in FIG. 12 are always within 3 meters, and the average of the deviations is about 1.5 meters only. It can be seen that after the second satellite is removed, better positioning accuracy can be achieved by the satellites in use 20 to perform positioning.

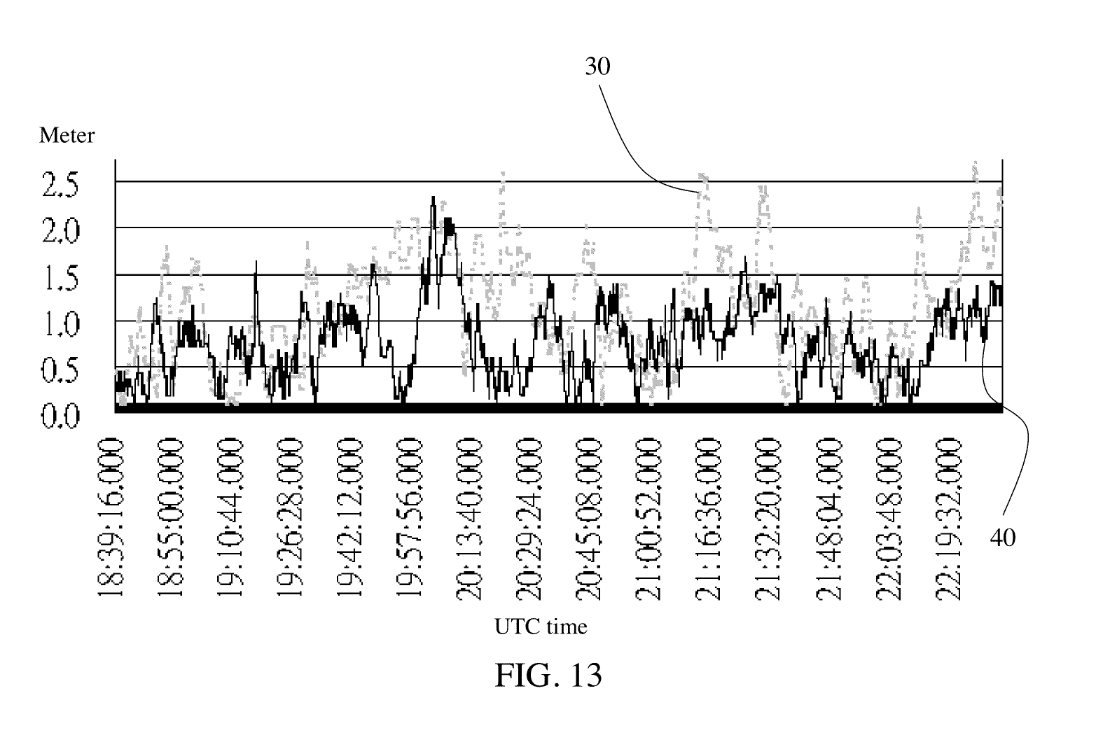

FIG. 13 is a schematic comparison view of deviations according to an embodiment. FIG. 13 illustrates the deviation curve 31 when the original satellites in use 20 are used to perform positioning and an adjusted deviation curve 40 when the satellites in use 20 having the first satellite or the second satellite removed are used to perform positioning. It can be easily seen that the adjusted deviation curve 40 is substantially lower than the original deviation curve 31.

In view of the above content, according to the satellite-based positioning method, the first satellite that may incur the geometric error and the second satellite that may make the signal strength varied rate too large due to the problem of shelter can be found, and the satellites in use having the first satellite or/and the second satellite removed are used to perform positioning. Furthermore, the satellite-based positioning method only needs the basic satellite signals to perform the rapid and accurate positioning.

What is claimed is:

1. A satellite-based positioning method, applicable in a Global Positioning System (GPS) receiver, the satellite-based positioning method comprising:
obtaining a plurality of satellites in use by searching;
calculating every satellite vector between each of the satellites in use and the GPS receiver;
selecting three of the satellites in use in sequence as a satellite candidate set, searching for one of the satellite candidate sets forming a geometric error relation according to the satellite vectors, and taking at least one of the satellites in use in the satellite candidate set forming the geometric error relation as a first satellite;
searching for at least one second satellite in the satellites in use, wherein a signal strength varied rate of the second satellite is greater than a varied rate threshold; and
using the satellites in use having the first satellite or the second satellite removed to perform positioning.

2. The satellite-based positioning method according to claim 1, wherein the step of obtaining the satellites in use by searching comprises:
initializing the GPS receiver and obtaining a plurality of satellites in-view, wherein the satellites in-view comprise the satellites in use;
receiving a satellite signal of each of the satellites in use and the satellites in-view in a plurality of directions individually; and
writing satellite information of each of the multiple satellites in use and the satellites in-view in a GPS detection table according to the satellite signals.

3. The satellite-based positioning method according to claim 2, wherein the satellite information comprises a signal strength value, a satellite altitude value, an azimuth angle, an elevation angle, a correction orientation, and a correction signal strength of the satellite in use or the satellite in-view, and the correction orientation or the correction signal strength is used for searching for the first satellite or the second satellite.

4. The satellite-based positioning method according to claim 1, wherein the step of selecting three of the satellites in use in sequence as the satellite candidate set, searching for one of the satellite candidate sets forming the geometric error relation according to the satellite vectors, and using the at least one of the satellites in use in the satellite candidate set forming the geometric error relation as the first satellite comprises:
selecting three of the satellites in use in sequence as the satellite candidate set;
calculating three vectors between the satellites of the satellite candidate set according to the satellite vectors of the satellite candidate set;
calculating three angles between the satellites of the satellite candidate set according to the vectors between the satellites of the satellite candidate set; and
when any one of the angles between the satellites is smaller than an threshold angle, taking the satellite candidate set of which the angle between the satellites is smaller than the threshold angle as the satellite candidate set forming the geometric error relation, and taking at least one of the satellites in use of the satellite candidate set forming the geometric error relation as the first satellite.

5. The satellite-based positioning method according to claim 1, wherein the step of selecting three of the satellites in use in sequence as the satellite candidate set, searching for the satellite candidate set forming the geometric error relation according to the satellite vectors, and using the at least one of the satellites in use in the satellite candidate set forming the geometric error relation as the first satellite comprises:
selecting three of the multiple satellites in use in sequence as the satellite candidate set;
calculating an azimuth angle θi between each of three satellites i in use in the satellite candidate set and the GPS receiver one by one according to the satellite vectors; and
when an azimuth angle θj of any one of the other obtained satellites j in use of the satellite candidate set is smaller than (θi+π/2) or is greater than or equal to (θi−π/2), taking the satellite candidate set of which the satellite j in use has the azimuth angle θj smaller than (θi+π/2) or greater than or equal to (θi−π/2) as the satellite candidate set forming the geometric error relation, and taking the satellite j in use having the azimuth angle θj smaller than (θi+π/2) or greater than or equal to (θi−n/2) as the first satellite.

6. The satellite-based positioning method according to claim 1, wherein before the step of using the satellites in use having the first satellite or the second satellite removed to perform positioning, the satellite-based positioning method further comprises:
recording the satellite in use having a lowest signal strength value and the satellite in use having a smallest elevation angle.

7. The satellite-based positioning method according to claim 6, wherein the step of using the satellites in use having the first satellite or the second satellite removed to perform positioning comprises:
calculating a deviation of current positioning; and
when the deviation of current positioning is greater than a deviation threshold, using the satellites in use having the first satellite or the second satellite removed to perform positioning.

8. The satellite-based positioning method according to claim 6, wherein the step of using the satellites in use having the first satellite or the second satellite removed to perform positioning comprises:
adjusting at least one positioning parameter corresponding to the multiple satellites in use in the GPS receiver to remove the first satellite or the second satellite; and
using the satellites in use having the first satellite or the second satellite removed to perform positioning.

9. The satellite-based positioning method according to claim 8, wherein the positioning parameter comprises a strength mask value, and the step of adjusting the positioning parameter corresponding to the satellites in use in the GPS receiver to remove the first satellite or the second satellite comprises:
when the first satellite or the second satellite is the satellite in use having the lowest signal strength value, increasing the strength mask value to remove the satellite in use having the lowest signal strength value.

10. The satellite-based positioning method according to claim 8, wherein the positioning parameter comprises an elevation angle mask value, and the step of adjusting the positioning parameter corresponding to the satellites in use in the GPS receiver to remove the first satellite or the second satellite comprises:
when the first satellite or the second satellite is the satellite in use having the smallest elevation angle, gradually increasing the elevation angle mask value at an elevation angle spacing, until the satellite in use having the smallest elevation angle is removed.

11. The satellite-based positioning method according to claim 10, wherein the elevation angle spacing is 0.5 degree.

12. The satellite-based positioning method according to claim 1, wherein the step of using the satellites in use having the first satellite or the second satellite removed to perform positioning comprises:
calculating a deviation of current positioning; and
when the deviation of current positioning is greater than a deviation threshold, using the satellites in use having the first satellite or the second satellite removed to perform positioning.

13. The satellite-based positioning method according to claim 12, wherein when the deviation of current positioning is greater than a deviation of previous positioning and the deviation of current positioning is greater than the deviation threshold, the satellites in use having the first satellite or the second satellite removed is used to perform the positioning, and the deviation of previous positioning and the deviation of current positioning are calculated by using a two-dimensional root-mean-square (2DRMS) deviation.

14. The satellite-based positioning method according to claim 12, wherein when the deviation of current positioning is greater than a deviation of pre-estimated positioning and the deviation of current positioning is greater than the deviation threshold, the satellites in use having the first satellite or the second satellite removed is used for perform positioning, and the deviation of pre-estimated positioning is calculated by the application of the Taylor expansion.

15. The satellite-based positioning method according to claim 1, wherein the step of using the satellites in use having the first satellite or the second satellite removed to perform positioning comprises:
adjusting at least one positioning parameter corresponding to the satellites in use in the GPS receiver to remove the first satellite or the second satellite; and
using the multiple satellites in use having the first satellite or the second satellite removed to perform positioning.

16. The satellite-based positioning method according to claim 17, wherein the positioning parameter comprises a strength mask value, and the step of adjusting the positioning parameter corresponding to the satellites in use in the GPS receiver to remove the first satellite or the second satellite comprises:
increasing the strength mask value to remove the at least one first satellite or at least one second satellite.

17. The satellite-based positioning method according to claim 17, wherein the positioning parameter comprises an elevation angle mask value, and the step of adjusting the positioning parameter corresponding to the satellites in use in the GPS receiver to remove the first satellite or the second satellite comprises:
gradually increasing the elevation angle mask value by an elevation angle spacing, until the at least one first satellite or the at least one second satellite is removed, and the elevation angle spacing is 0.5 degree.

18. The satellite-based positioning method according to claim 17, wherein the step of using the satellites in use having the first satellite or the second satellite removed to perform positioning further comprises:
adjusting at least one of the positioning parameter to add at least one tracking satellite among the satellites in-view as a satellite in use, and the step of using the satellites in use having the first satellite or the second satellite removed to perform positioning comprises using the satellites in use having the first satellite or the second satellite removed and having the tracking satellite newly added to perform positioning.
setting a Wide Area Augmentation System (WAAS) parameter to be enabled.

19. The satellite-based positioning method according to claim 1, wherein before the step of using the satellites in use having the first satellite or the second satellite removed to perform positioning, the method further comprises:
setting a Dilution of Precision (DOP) parameter to be enabled.

20. A satellite-based positioning method, applicable in a Global Positioning System (GPS) receiver, comprising:
obtaining a plurality of satellites in use by searching; and
calculating every satellite vector between each of the satellites in use and the GPS receiver;
selecting three of the satellites in use in sequence as a satellite candidate set, searching for one of the satellite candidate sets forming a geometric error relation according to the satellite vectors, and taking at least one of the satellites in use in the satellite candidate set forming the geometric error relation as a first satellite;
searching for at least one second satellite in the satellites in use, wherein a signal strength varied rate of the second satellite is greater than a varied rate threshold;
calculating a deviation of current positioning; and
when the deviation of current positioning is greater than a deviation threshold, using the satellites in use having the first satellite or the second satellite removed to perform positioning.
